(19) United States
(12) Patent Application Publication
(10) Pub. No.: US 2026/0156045 A1
(43) Pub. Date: Jun. 4, 2026

(54) MACHINE-LEARNING ASSISTED NETWORK PERFORMANCE MANAGEMENT

(71) Applicant: Telefonaktiebolaget LM Ericsson (publ), Stockholm (SE)

(72) Inventors: Javier RASINES, STOCKHOLM (SE); Raúl MARTÍN CUERDO, MADRID (ES)

(21) Appl. No.: 19/126,660

(22) PCT Filed: Mar. 22, 2023
(86) PCT No.: PCT/EP2023/057256

§ 371 Date: May 2, 2025

(30) Foreign Application Priority Data
Nov. 2, 2022 (EP) 22383054.8

(51) Int. Cl. H04L 41/16; H04L 41/0816

(52) U.S. Cl. CPC H04L 41/16; H04L 41/0816

(57) ABSTRACT

Computer-implemented method and apparatus for Machine Learning (ML) assisted radio network performance management. A method comprises receiving at a ML agent hosting a ML model a dataset comprising experience data relating to a radio network. The method further comprises encoding the experience data to generate vectors representing the data in an embedding space. The method also comprises clustering, classifying and decoding the data, then selecting a subset of experience data based on the classification. The method also comprises using the selected subset of experience data to generate one or more suggested network actions, and modifying the radio network based on the suggested network actions.

### TECHNICAL FIELD

Embodiments described herein relate to methods and apparatus for radio network performance management, in particular for Machine Learning (ML) assisted radio network performance management.

### BACKGROUND

In a variety of environments, ML methods may be utilised in a number of systems which are similar but not (necessarily) identical. In distributed environments such as radio networks, distributed cloud computing networks, and Internet of Things (IoT) networks there are typically many devices that perform similar tasks but do not necessarily have the same configuration, for example, the same underlying hardware and measurement capabilities, the same location and interconnections, and so on. Accordingly, different components within distributed environments may suffer from similar but non-identical problems and issues. Detection of issues with components in distributed environments can require extensive time and effort.

ML models may be used to automatically detect problematic behaviours in distributed environments; taking the example of a radio network the use of ML models may assist mobile operators in improving network performance, responding faster to issues and being more precise when addressing existing network performance issues. ML models may use a softmax activation function in the output layer of a neural network to generate an output that is a vector of probabilities, assisting the model in determining the nature of a problem impacting a cell of the radio network.

Typically, in production, existing methods gather data from live networks (typically performance metric counters and/or Key Performance Indicators, KPIs, such as percentages of packets dropped, average lag values, cell throughput, and so on) and give it to the ML model. The ML model then process the data to determines what problem exists (if any). Some methods also compute a heuristic value to determine if a cell under examination behaves in a way that the model has not seen before. This may be of some use in determining the reliability of the ML model outputs; ML models will typically generate incorrect outputs when presented with data too different to that used during training of the ML model. Where the heuristic value indicates that the cell data is too different from that seen in training, for example if the heuristic value is higher than a selected threshold, then the output of the ML model may be disregarded.

Although existing ML models may assist in the identification of issues with distributed environments, the usefulness of the ML models may be constrained due to the way in which the data used to train the ML models is selected. There are three main issues that may impact data selection:
(1) Multi-issue detection. As a consequence of the use of softmax activation (see above), existing models are typically configured to output a probability distribution over all potential issues. Accordingly, in scenarios where a sample has more than one issue, the distribution of probabilities may not accurately reflect the relevance of the different issues. By way of example, the model output may present a complementary distribution for 2 main issues such as 80%+20% while both issues are visible and relevant for the sample under analysis.
(2) For typical existing systems, training data can only have 1 label; this may make the process of gathering data to train and improve models more complicated. When a data point has 2 issues present, a determination must be made (typically by a human expert) to either selecting one issue (and face the risk of degrading the model's performance during training) or discard the sample for training purposes (with the problem of losing information and not having not enough examples of complex production scenarios). Management of samples in between existing dense clusters (labels) on the multidimensional space is complex and time consuming, necessitating frequent re-trainings to maintain sufficient model accuracy.
(3) Out-of-distribution heuristics. Heuristic values are computed from the output probability distribution. However, crafting a metric that will work reliably for most scenarios is challenging. Typically, the heuristic value is used to impose a hard deterministic threshold to find the out of distribution tail that is not directly derived from the data distribution, with the risk on being inaccurate when performing the filtering and triggering the model retraining in the life cycle management stage

### SUMMARY

It is an object of the present disclosure to provide methods, apparatuses and computer readable media which at least partially address one or more of the challenges discussed above. In particular, it is an object of the present disclosure to provide methods and apparatus for ML assisted radio network performance management that support improved data labelling and selection of experience data, allowing for more efficient and effective model training.

The present disclosure provides a computer-implemented method for radio network performance management. The method comprises receiving, at a first ML agent hosting a first ML model, a dataset comprising a plurality of experience datums relating to a radio network. The method further comprises encoding the experience data using the first ML model to generate vectors representing each of the experience datums in an embedding space, then clustering and classifying the vectors in the embedding space. The method also comprises decoding the classified vectors to regenerate the experience datums, and selecting a subset of experience datums based on the classification of the vectors. The method also comprises using the selected subset of experience datums to generate one or more suggested network actions, and modifying the radio network based on the suggested network actions. The method may provide more effective suggested network actions to be used in modifying a network, and may therefore support efficient network operation. The method may also support more precise diagnosis of issues in a radio network and/or improved training of further ML models. The method may further support determinations of when further model training may be effectively employed and the ongoing accuracy of embodiments.

In some embodiments, the step of using the selected subset of experience datums to generate one or more suggested network actions may comprise training a second ML model utilising the subset of experience datums. The method may further comprise halting the training of the second ML model when a performance threshold is reached, and processing active radio network data using the second ML model to generate the one or more suggested network actions. The selection of subsets of experience datums for use in training second ML models may be a particularly effective implementation of embodiments.

The present disclosure also provides a first ML agent hosting a first ML model for radio network performance management. The first ML agent comprising processing circuitry and a memory containing instructions executable by the processing circuitry. The first ML agent is operable to receive a dataset comprising a plurality of experience datums relating to a radio network, encode the experience data using the first ML model to generate vectors representing each of the experience datums in an embedding space, and cluster and classify the vectors in the embedding space. The first ML agent is also operable to decode the classified vectors to regenerate the experience datums, select a subset of experience datums based on the classification of the vectors, and use the selected subset of experience datums to generate one or more suggested network actions. The first ML agent is further operable to modify the radio network based on the suggested network actions. The first ML agent may provide some or all of the advantages discussed above in the context of the computer implemented method.

### BRIEF DESCRIPTION OF DRAWINGS

The present disclosure is described, by way of example only, with reference to the following figures, in which:—

FIG. 1 is a flowchart of a method in accordance with embodiments;

FIGS. 2A and 2B are schematic diagrams of ML agents in accordance with embodiments;

FIG. 3 is flowchart showing an example of the training and use of the first ML model in accordance with embodiments;

FIG. 4 is a flowchart showing processes for training and utilising the first ML model in accordance with embodiments.

### DETAILED DESCRIPTION

For the purpose of explanation, details are set forth in the following description in order to provide a thorough understanding of the embodiments disclosed. It will be apparent, however, to those skilled in the art that the embodiments may be implemented without these specific details or with an equivalent arrangement.

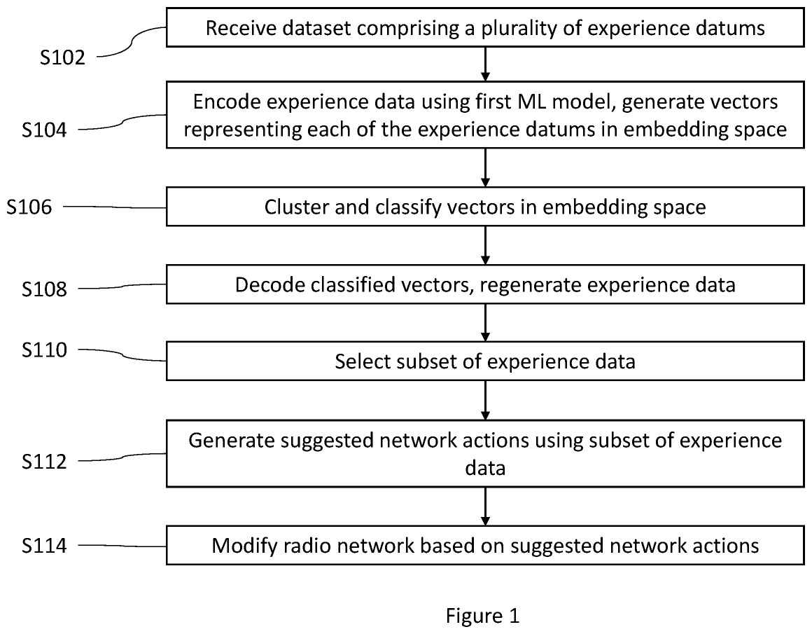

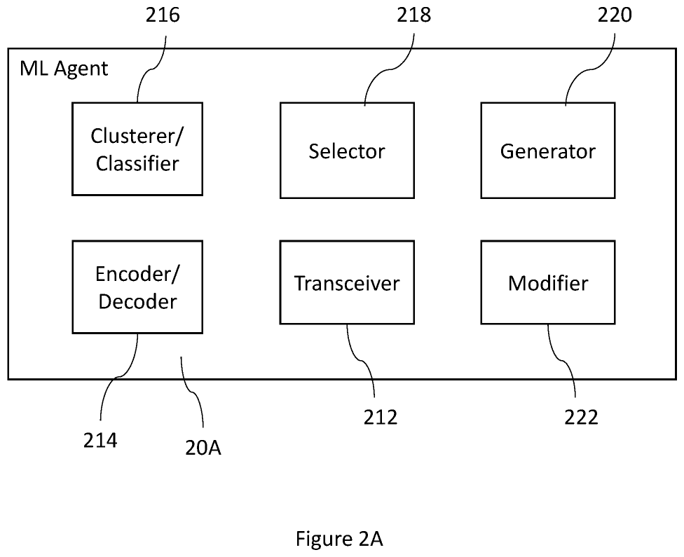

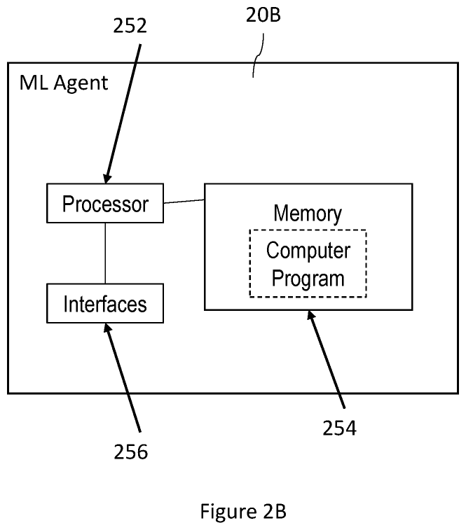

Embodiments of the present disclosure provide computer-implemented methods for radio network performance management. A method in accordance with embodiments is illustrated by FIG. 1, which is a flow chart showing process steps of a method for radio network performance management. FIG. 2A and FIG. 2B are schematic overviews of ML agents 20A and 20B (collectively 20) which may perform methods in accordance with embodiments.

In some embodiments ML agent 20 may form part of a wireless communication network such as a 3^{rd} Generation Partnership Project (3GPP), 4^{th} Generation (4G) or 5^{th} Generation (5G) network. Where the ML agent 20 forms part of a wireless communications network, the ML agent may be located in a suitable component of the network, for example, may form part of a Core Network Node (CNN) or base station (which may be 4th Generation, 4G, Evolved Node Bs, eNB, or 5th Generation, 5G, next Generation Node Bs, gNBs, for example.

As shown in step S102 of FIG. 1 the method comprises receiving, at a first ML agent 20 hosting a first ML model, a dataset comprising a plurality (that is, two or more) of experience datums relating to a radio network. Any suitable type of ML model may be used as the first ML model, by way of example, a Deep Learning (DL) ML model may be used. In some embodiments, the dataset may comprise information measurements from network nodes in the radio network potentially including one or more of: Quality of Service, QoS, metrics; percentage of packets dropped; average lag measurements; uplink data rates; downlink data rates; volumes of traffic exchanged; consumption of available network node resources; call flow continuity, and so on. The dataset may also include actions performed on the radio network (for example, activating or deactivating all or part of one or more base stations), and the response of the radio network to those actions (decrease in the percentage of packets dropped, decreased lag, and so on). The experience datums in the dataset may comprise one or more experience datums that are indicative of plural issues; processing of such datums using existing systems applying softmax activation functions may be problematic, at least for the reasons discussed above. The receiving of the plurality of experience datums may, for example, be performed by a transceiver 212 of ML agent 20A as shown in FIG. 2A, or in accordance with a computer program stored in a memory 254, executed by a processor 252 in conjunction with one or more interfaces 256 (wherein the interfaces 256 may comprise a transceiver) of ML agent 20B as shown in FIG. 2B.

When the dataset of experience datums relating to the radio network has been received, the experience data may then be encoded using the first ML model; the encoding generates a vector for each experience datum, wherein the vector represents the experience datum in an embedding space. The encoding of the plurality of experience datums may, for example, be performed by an encoder/decoder 214 of ML agent 20A as shown in FIG. 2A, or in accordance with a computer program stored in a memory 254, executed by a processor 252 in conjunction with one or more interfaces 256 of ML agent 20B as shown in FIG. 2B.

The embedding space is a multidimensional space; the number of dimensions used may be determined based on the information provided in the experience data, the properties of the radio network to which the experience data relates, and so on. By way of example, an 8 dimensional space may be used. The generated vectors represent the experience datums in the embedding space, with the values of the vectors determined by the information included in the experience datums. The generated vectors are then plotted in the embedding space. The embedding space also comprises a plurality of clusters (formed from vectors representing previously encoded experience data); the clusters of vectors each represent experience datums having known properties, for example, experience datums indicative of a radio network experiencing one or more issues. By way of example, one of the clusters may be formed from vectors representing experience data from a network suffering from a shortage of capacity, and this shortage of capacity would be reflected in the information included in the experience data (by longer transit times for data packets, for example). The experience data used to encode the vectors for the clusters may be selected, for example, by a human expert.

Each of the clusters may have at least one representative point; the exact nature of the representative point or points may vary but typically the representative point of a cluster is the centre point of that cluster in the embedding space (that is, the cluster centroid) and there is a single representative point per cluster. The representative point or points of the clusters are typically used following the encoding of the vectors; in the clustering and classifying of the vectors in the embedding space. The clustering and classifying of the encoded vectors in the embedding space may, for example, be performed by a clusterer/classifier 216 of ML agent 20A as shown in FIG. 2A, or in accordance with a computer program stored in a memory 254, executed by a processor 252 in conjunction with one or more interfaces 256 of ML agent 20B as shown in FIG. 2B. The formation of the clusters and calculation of the representative points may take place during a training phase of the first ML model; by way of example, the clusters may be formed as discussed in “Unsupervised Deep Embedding for Clustering Analysis” by Xie, J., Girshick, R. and Farhadi, A., available at https://arxiv.org/abs/1511.06335 as of 25 Oct. 2022.

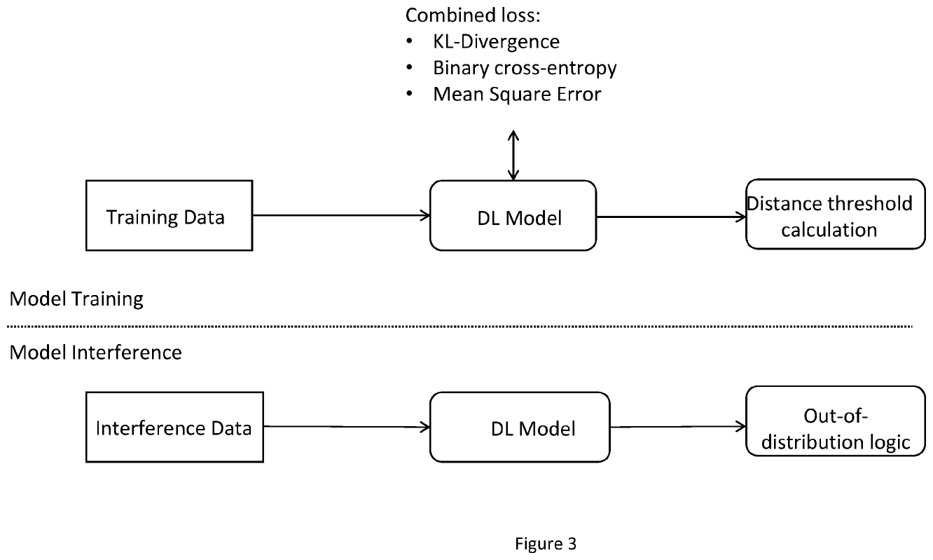

FIG. 3 is a flowchart showing an example of the training and use of the first ML model in accordance with some embodiments. The training of the model is shown at the top of the figure, while the use of the model is shown at the bottom of the figure. In the example shown in FIG. 3, the first ML model (in this example, a DL model) is trained using training data; this may be supervised training in which the training data has been selected by a human expert. The processing of training data by the first ML model may continue until a suitable point, for example, until the losses plateau (stop improving). In the example shown in FIG. 3, separate layers of the DL model are to be used for clustering, classification and decoding; different loss functions may be used for these different layers. Table 1 below shows loss functions that may be used in the layers of the DL model in the example of FIG. 3.

TABLE 1

| Layer | Loss Function |
|---|---|
| Clustering Layer | KL-Divergence |
| Classifier Layer | Binary Cross-entropy |
| Decoder Layer | Mean Squared Error |

The combined loss function may be calculated as the sum of the three loss functions for the three layers, as illustrated in FIG. 3; when this combined loss function plateaus, the DL model may stop processing training data. At this point, the training data will have been used to form clusters in embedding space. The representative points of the clusters (for example, cluster centroids) may then be determined, and distance and proximity thresholds for each of the clusters calculated. By way of example, the 95th quantiles of the distances for each cluster may be computed and stored as thresholds. When the distance and proximity thresholds have been calculated, the DL model training may stop. The DL model may then be used to process experience data (referred to in FIG. 3 as inference data); this is discussed in greater detail below.

Returning to the FIG. 1 flowchart, the encoded vectors, once plotted in embedding space, will be located a given distance from each of the clusters in the embedding space. The relative distances between a given encoding vector and each of the clusters may be used to attempt to assign the vector to a cluster, and subsequently to classify the vector. Typically, in the classifying, each of the encoded vectors is assigned to one or more predetermined classes. In some embodiments, the number of classes of vectors used in the classification is based on the clustering of the vectors in the embedding space, and the number of classes may be equal to the number of clusters. Each of the clusters in the embedding space may correspond to a given class of radio network issue (as discussed above), wherein the clusters are formed from vectors corresponding to data displaying the corresponding class of radio network issue. Accordingly, by determining the distance in embedding space between each cluster (for example, the representative point or points of said cluster) and an encoded vector, the relative similarities of the information represented by that encoded vector and the experience data represented by each cluster may be determined, allowing the encoded vector to be assigned to a cluster that most closely corresponds to the encoded vector.

In some embodiments, when a given vector is closer than a proximity threshold to a given representative point of a given cluster, the given vector is assigned a class associated with that given cluster. Where the given vector is closer than a proximity threshold to representative points of more than one cluster (by way of example, two clusters), the given vector may be assigned classes associated with both clusters. There may also be situations in which an encoded vector represents an experience datum which is significantly different from all of the vectors forming the clusters in the embedding space; this may be indicative of an experience datum for a radio network experiencing an issue that has not previously been seen by the first ML model, for example. Where this is the case, the encoded vector may be located further than a distance threshold from all of the representative points of the clusters. In response to this situation, the experience datum represented by the encoded vector may be labelled as problematic, that is, out of distribution. Where a substantial number of out of distribution experience datums are recorded, this may be indicative of a need to retrain the first ML model, to potentially include one or more further clusters representing the new issues displayed by the out of distribution datums.

A further possible situation for a given vector is that, in embedding space, the vector is not greater than a distance threshold from all of the representative points, but is also not closer than the proximity threshold to any representative point. That is, the given vector may be within the general region of embedding space to the clusters, but not proximate to any particular cluster. Where this is the case, the given vector may be assigned no class, and may also not be identified as out of distribution. A potential reason for given vectors assigned no class is that the behaviour of the radio network from which the experience data has been obtained has changed over time, that is, has changed since the clusters in the embedded space were generated. Accordingly, where the rate at which vectors within the general region of embedding space as the clusters, but not proximate to any particular cluster are encoded increases, this may be indicative of a situation in which the network behaviour has changed and retraining of the first ML model may be advisable. In some embodiments, a ML agent may be configured such that when a predetermined number and/or percentage of vectors are identified as problematic and/or not assigned a class, the retraining of the first ML model is automatically instigated. The determination of how to classify experience datums, and/or whether to retrain the first ML model, may be made using out_of_distribution logic as shown in FIG. 3.

Following the classification of the vectors, the classified vectors may then be decoded to regenerate the experience datums, as shown in step S108 of FIG. 1. The classification of the vectors is retained by the experience datums; accordingly, the decoding process results in a set of experience datums which are each classified into one or more classes, typically classes indicating that the experience datums contain information indicative of a particular radio network issue. The decoding of the encoded vectors may, for example, be performed by the encoder/decoder 214 of ML agent 20A as shown in FIG. 2A, or in accordance with a computer program stored in a memory 254, executed by a processor 252 in conjunction with one or more interfaces 256 of ML agent 20B as shown in FIG. 2B. In some embodiments, additional new data comprising pluralities of experience datums may be periodically received from the radio network, or from several radio networks; that is, the dataset may be updated to include new data on a periodic basis. Where this is the case, the steps of encoding, clustering and classifying, and decoding may be repeated each time the dataset is updated with new data; these steps may be repeated for only the datums in the new data or for all of the dataset. In this way, embodiments may ensure that all of the data in the dataset has been classified into one or more classes.

Once the classified experience data has been obtained, a subset of the experience datums is selected based on the classes of the encoded vectors, as shown in step S110 of FIG. 1. The selection of the subset of experience datums may, for example, be performed by the selector 218 of ML agent 20A as shown in FIG. 2A, or in accordance with a computer program stored in a memory 254, executed by a processor 252 in conjunction with one or more interfaces 256 of ML agent 20B as shown in FIG. 2B. The selected experience datums may then be used to generate one or more suggested network actions, as shown in step S112 of FIG. 1. The generation of the one or more suggested actions using the subset of experience datums may, for example, be performed by the generator 220 of ML agent 20A as shown in FIG. 2A, or in accordance with a computer program stored in a memory 254, executed by a processor 252 in conjunction with one or more interfaces 256 of ML agent 20B as shown in FIG. 2B. Different embodiments may use the selected subset of experience datums in different ways to generate the suggested actions, for example, the selected subset of experience datums may be analysed using different automated data analytics techniques or reviewed by human experts to generate the suggested actions. However, the subset of experience datums may be particularly well suited for use in training a further (second) ML model.

Where the subset of experience datums are used in the training of a second ML model, the subset may be selected based on the classes of the data to train the second ML model with relevant data. The second ML model may then be trained using the subset of experience data tagged with relevant classes to the second ML model. Any suitable form of training, for example, supervised or unsupervised learning, may be used. The second ML model may be trained using selected experience datums (that have been tagged with the relevant classes) until a performance threshold for the second ML model is reached. Any suitable performance threshold as will be familiar to those in the art may be used, for example, when provided with test data 95% of the actions suggested by the second ML model would provide an improvement in radio network performance. Once the second ML model has reached the performance threshold, the training of the second ML model may be halted and the second ML model may then be ready for use. The second ML model may then be used to process data from an active radio network; the output of the second ML model following this processing may be the one or more suggested network actions. The second ML model may then continue to be used to provide suggested network actions, based on active radio network data, potentially with periodic retraining to ensure the second ML model remains current. The data from the active radio network may contain similar information to the experience data, save that the data from the active radio network does not comprise actions taken or the results of those actions. By way of example, the data from the active radio network may comprise one or more of: Quality of Service, QoS, metrics; percentage of packets dropped; average lag measurements; uplink data rates; downlink data rates; volumes of traffic exchanged; consumption of available network node resources; call flow continuity, and so on.

When the one or more suggested network actions have been generated, either using a second ML model or human expert review (both as discussed above) or in another way, the radio network may then be modified based on the suggested network actions, as shown in step S114 of FIG. 1. Where plural suggested network actions are generated, a single action from this plurality may be selected to be applied to the network or several may be applied. Where one suggested network action is generated, that network action may be applied. The modification of the radio network based on the suggested action(s) may, for example, be performed by the modifier 222 of ML agent 20A as shown in FIG. 2A that may send instructions to other network components using the transceiver 212, or in accordance with a computer program stored in a memory 254, executed by a processor 252 in conjunction with one or more interfaces 256 (which may include a transceiver) of ML agent 20B as shown in FIG. 2B. By way of example, the suggested actions for modifications to the radio network may include activation of all or part of a network node; deactivation of all or part of a network node; transferring responsibility for User Equipments, UEs, between network nodes; limiting service provision to one or more UEs, and so on.

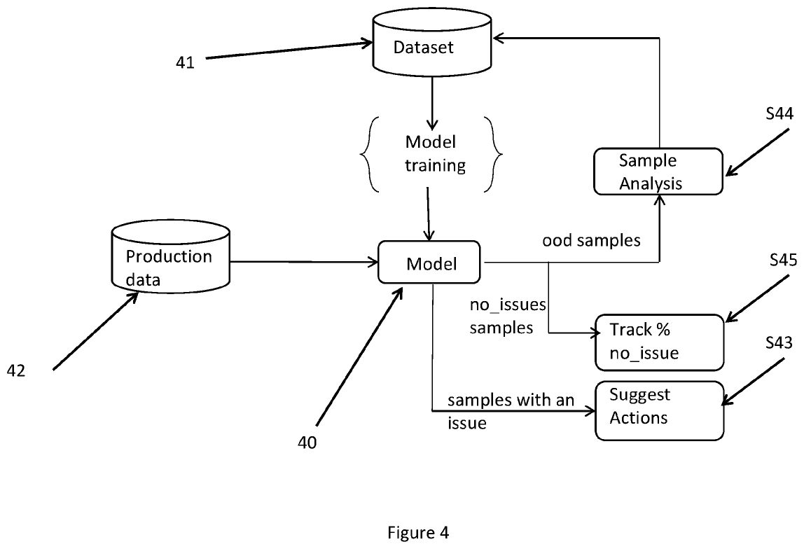

FIG. 4 is a flowchart showing processes for training and utilising the first ML model 40 in accordance with some embodiments. FIG. 4 illustrates an example in which a ML model for classifying network issues is to be trained using a training dataset 41. The training dataset may be compiled from network information, for example using hourly counters from cells. The model is trained as discussed above, for example, as discussed with reference to the FIG. 3 example. Once the training is completed, the ML model may be used to process the active data from a network (production data 42), to identify active data indicating an issue with the network and suggest actions to address the issue (S43). The distribution of no issue and out of distribution (ood) samples may be tracked to monitor the model performance and, when certain thresholds are reached, to trigger model updates. The tracking may include, for example, one or more of:
Analysing samples identified as out of distribution, potentially using human experts or other automated analytics experts (see S44). If some of the samples are determined to be useful, the samples may be added to an updated version of the training dataset. When sufficient samples are obtained, the model may be retrained using the updated version of the dataset.
Tracking the percentage of no issue samples (S45). The radio network behaviour may change over time. As the network behaviour diverges from the behaviour expected by the ML model, the amount of samples being identified as no issue may also increase. Accordingly, by tracking the percentage of no issue samples, further training of the ML model in order to keep the ML model up to date with network conditions may be triggered at a suitable time.

Some of the embodiments such as those discussed above with reference to FIG. 4 may also be used to support an automated life cycle management (LCM) procedure that will automatically retrain and update the ML model without human intervention, allowing continuous optimization and monitoring of the network's performance.

Some of the embodiments may provide more effective suggested network actions to be used in modifying a network, and may therefore support efficient network operation. Some of the embodiments allow multiple classes to be assigned to a datum; by inferring independent probabilities for each of a number of issues (associated with classes), if several issues are present in the data, the first ML model can estimate each of the issues. Some of the embodiments thereby support more precise diagnosis of issues in a radio network and/or improved training of further ML models. The labelling of datums with multiple classes also allows more precise groupings of data points and removes the need to select or discard complex samples (displaying plural issues). Some of the embodiments may also support the identification of samples significantly different from those seen during a training/clustering phase (using distance measurements to clusters in embedding space, as discussed above), without relying on heuristics. Accordingly, determinations of when further model training may be effectively employed are supported and the ongoing accuracy of embodiments may be provided for.

It will be appreciated that examples of the present disclosure may be virtualised, such that the methods and processes described herein may be run in a cloud environment.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

In general, the various exemplary embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, RAM, etc. As will be appreciated by one of skill in the art, the function of the program modules may be combined or distributed as desired in various embodiments. In addition, the function may be embodied in whole or in part in firmware or hardware equivalents such as integrated circuits, field programmable gate arrays (FPGA), and the like.

References in the present disclosure to “one embodiment”, “an embodiment” and so on, indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments whether or not explicitly described.

It should be understood that, although the terms “first”, “second” and so on may be used herein to describe various elements, these elements should not be limited by these terms. These terms are only used to distinguish one element from another. For example, a first element could be termed a second element, and similarly, a second element could be termed a first element, without departing from the scope of the disclosure. As used herein, the term “and/or” includes any and all combinations of one or more of the associated listed terms.

The terminology used herein is for the purpose of describing particular embodiments only and is not intended to limit the present disclosure. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components, but do not preclude the presence or addition of one or more other features, elements, components and/or combinations thereof. The terms “connect”, “connects”, “connecting” and/or “connected” used herein cover the direct and/or indirect connection between two elements.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure. For the avoidance of doubt, the scope of the disclosure is defined by the claims.

1. A computer-implemented method for radio network performance management, the method comprising:
receiving, at a first Machine Learning, ML, agent hosting a first ML model, a dataset comprising a plurality of experience datums relating to a radio network;
encoding the experience data using the first ML model to generate vectors representing each of the experience datums in an embedding space;
clustering and classifying the vectors in the embedding space;
decoding the classified vectors to regenerate the experience datums;
selecting a subset of experience datums based on the classification of the vectors;
using the selected subset of experience datums to generate one or more suggested network actions; and
modifying the radio network based on the suggested network actions.

2. The method of claim 1, wherein the step of using the selected subset of experience datums to generate one or more suggested network actions comprises:
training a second ML model utilising the subset of experience datums;
halting the training of the second ML model when a performance threshold is reached; and
processing active radio network data using the second ML model to generate the one or more suggested network actions.

3. The method of claim 1, wherein the number of classes of vectors used in the classification is based on the clustering of the vectors in the embedding space.

4. The method of claim 3, wherein the number of classes is equal to the number of clusters.

5. The method of claim 4, wherein each of the clusters in the embedding space corresponds to a given class of radio network issue, and wherein the clusters are formed from vectors corresponding to data displaying the corresponding class of radio network issue.

6. The method of claim 1 wherein vectors are assigned a class in the classifying step based on proximity in the embedding space to representative points of the clusters in the embedding space.

7. The method of claim 6 wherein, when a given vector is closer than a proximity threshold to at least one given representative point of at least one given cluster, the given vector is assigned one or more classes associated with the at least one given cluster.

8. The method of claim 7 wherein, if the given vector is greater than a distance threshold from all representative points, the given vector is identified as problematic.

9. The method of claim 7 wherein if the given vector is not greater than a distance threshold from all representative points, and is not closer than the proximity threshold to any representative point, the given vector is not assigned to a class.

10. The method of claim 8 further comprising, when a predetermined number and/or percentage of vectors are identified as problematic or not assigned a class, retraining the first ML model.

11. The method of claim 1, wherein the dataset comprising a plurality of experience datums relating to the radio network is updated with new data from the radio network on a periodic basis.

12. The method of claim 11, wherein the steps of encoding, clustering and classifying, and decoding are repeated each time the dataset is updated with new data.

13. The method of claim 2, wherein the active radio network data comprises measurements from network nodes in the radio network including one or more of: Quality of Service, QoS, metrics; percentage of packets dropped; average lag measurements; uplink data rates; downlink data rates; volumes of traffic exchanged; consumption of available network node resources; and call flow continuity.

14. The method of claim 1, wherein modifying the radio network comprises one or more of: activation of all or part of a network node; deactivation of all or part of a network node; transferring responsibility for User Equipments, UEs, between network nodes; limiting service provision to one or more UEs.

15. The method of claim 1, wherein the classification of the vectors comprises identifying the vectors as representing experience datums indicative of network nodes exhibiting one or more issues.

16. The method of claim 1, wherein the first ML model is a Deep Learning, DL, model.

17. A first Machine Learning, ML, agent hosting a first ML model for radio network performance management, the first ML agent comprising processing circuitry and a memory containing instructions executable by the processing circuitry, whereby the first ML agent is operable to:
receive a dataset comprising a plurality of experience datums relating to a radio network;
encode the experience data using the first ML model to generate vectors representing each of the experience datums in an embedding space;
cluster and classify the vectors in the embedding space;
decode the classified vectors to regenerate the experience datums;
select a subset of experience datums based on the classification of the vectors;
use the selected subset of experience datums to generate one or more suggested network actions; and
modify the radio network based on the suggested network actions.

18. The first ML agent of claim 17 wherein, when using the selected subset of experience datums to generate one or more suggested network actions, the first ML agent is further configured to:
train a second ML model utilising the subset of experience datums;
halt the training of the second ML model when a performance threshold is reached; and
process active radio network data using the second ML model to generate the one or more suggested network actions.

19. The first ML agent of claim 17, wherein the number of classes of vectors used in the classification is based on the clustering of the vectors in the embedding space.

20. The first ML agent of claim 19, wherein the number of classes is equal to the number of clusters.

21-33. (canceled)
